(19) United States
(12) Patent Application Publication
(10) Pub. No.: US 2002/0150723 A1
(43) Pub. Date: Oct. 17, 2002

(54) Surfaces which are self-cleaning by hydrophobic structures, and a process for their production

(75) Inventors: Markus Oles, Hattingen (DE); Edwin Nun, Billerbeck (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS GESELLSCHAFT F. TECHN. U. INNOVATION MBH, Marl (DE)

(21) Appl. No.: 10/118,257

(22) Filed: Apr. 9, 2002

(30) Foreign Application Priority Data
Apr. 12, 2001 (DE) 101 18 349.6

(51) Int. Cl. B32B 1/00

(52) U.S. Cl. 428/143; 264/232; 264/340

(57) ABSTRACT

A process for producing self-cleaning surfaces, in which an at least partially hydrophobic, surface structure is formed by securing particles on a polymer surface, which comprises applying, to the polymer surface, at least one solvent which comprises the particles and which solvates the polymer surface, and securing at least part of the particles to the polymer surface by removing the solvent; self-cleaning surfaces obtained by the process; and objects containing self-cleaning surfaces obtained by the process.

### BACKGROUND OF THE INVENTION

1. FIELD OF THE INVENTION

The present invention relates to surfaces which have an effective self-cleaning action by virtue of the introduction of hydrophobic particulate systems into a carrier material. The surface energy of these surfaces is very low. The invention describes a process for firm bonding of the particulate systems into the bulk material within polymer surfaces.

2. DISCUSSION OF THE BACKGROUND

It is known that if effective self-cleaning is to be obtained on an industrial surface, the surface must not only be very hydrophobic but also have a certain roughness. Suitable combinations of structure and hydrophobic properties permit even small amounts of water moving over the surface to entrain adherent dirt particles and thus clean the surface (WO 96/04123; U.S. Pat. No. 3,354,022).

Prior art in EP 0 933 388 is that self-cleaning surfaces of this type require an aspect ratio>1 and surface energy less than 20 mN/m. The aspect ratio here is defined as the quotient of the height of the structure to its width. The abovementioned criteria are satisfied in the natural world, for example on a lotus leaf. The surface of the plant, formed from a hydrophobic waxy material, has elevations separated from one another by a few μm. Water droplets essentially come into contact only with these peaks. There are many descriptions in the literature of water-repellant surfaces of this type.

Swiss Patent 268 258 describes a process which can produce structured surfaces by applying powders, such as kaolin, talc, clay or silica gel. The powders are secured to the surface by oils and resins based on organosilicon compounds (Examples 1 to 6). However, there is no description in that patent specification of the particle size distribution or the manner of introduction of the particles into the matrix.

EP 0 909 747 A1 teaches a process for producing a self-cleaning surface. The surface has hydrophobic elevations of height from 5 to 200 μm. A surface of this type is produced by applying a dispersion of powder particles and of an inert material in a siloxane solution, followed by curing. The structure-forming particles are therefore secured to the substrate by an auxiliary medium.

Processes for producing structured surfaces in polymers are likewise known. Besides the use of a master structure to give precise reproduction of these structures by injection molding or embossing processes, there are other known processes which utilize the application of particles to a surface, e.g. in U.S. Pat. No. 5,599,489. This process, too, again utilizes an adhesion-promoting layer between particles and bulk material. Processes suitable for developing the structures are etching and coating processes for adhesive application of the structure-forming powders, and also shaping processes using appropriately structured negative molds.

However, a common feature of all of these processes is that an adhesion promoter between carrier and particle system is used when applying particulate systems. There are many technical problems with the use of an adhesion promoter of this type. Firstly, the particles frequently become immersed in the adhesion promoter and thus can no longer provide the desired effect. Secondly, there are very few industrial systems available for the abrasion-resistant bonding of a hydrophobic primary particle into a material.

It is therefore an object of the present invention to carry out a process which, without adhesion promoters, can bond particulate systems or particles into the surface of various polymers.

### SUMMARY OF THE INVENTION

Surprisingly, it has been found that brief immersion or treatment of polymer surfaces into and, respectively, with solvents which comprise particles of the desired size can solvate the uppermost layer of the polymers and firmly bond the particles present in the solvent to the surface of the polymers. Once the solvent has been removed from the surface by evaporation/drying, the particulate systems (i.e. the particles) have become firmly anchored to the surface of the material.

The present invention therefore provides a process for producing self-cleaning surfaces, in which a suitable, at least partially hydrophobic, surface structure is created by securing particles on a polymer surface, which comprises applying, to the polymer surface, at least one solvent which comprises the particles and which solvates the polymer surface, and securing same part of the particles to the polymer surface by removing the solvent.

The present invention also provides a self-cleaning polymer surface produced by the above process and having an artificial, at least partially hydrophobic, surface structure made from elevations and depressions, wherein the elevations and depressions are formed by particles secured to the polymer surface.

### BRIEF DESCRIPTION OF THE DRAWINGS

FIGS. 1 and 2 show scanning electron micrographs (SEMs) of surfaces from the examples, produced according to the invention.

### DETAILED DESCRIPTION OF THE INVENTION

The process of the invention has the advantage that the particles can be bonded directly into a polymer surface and do not have to be secured to a surface by way of an auxiliary, e.g. an adhesive. Surfaces with self-cleaning properties can thus be provided without any need to consider the incompatibility of the surface with the auxiliary used.

The process of the invention for producing self-cleaning surfaces in which a suitable, at least partially hydrophobic, surface structure is created by securing particles on a polymer surface is based on applying, to the polymer surface, at least one solvent which comprises the particles and which solvates the polymer surface, and securing some part of the particles to the polymer surface by removing the solvent. The solvation of the polymer surface softens this surface, and at least some part of the particles can sink into the solvated surface. Once the solvent has been removed, the polymer surface hardens again, and the particles, at least some part of which has/have sunk into the polymer surface, have become secured to the polymer surface.

The particles used may be those which comprise at least one material selected from silicates, doped or fumed silicates, minerals, metal oxides, silicas, and polymers. The particles used are preferably those which have a particle diameter of from 0.02 to 100 μm, particularly preferably from 0.2 to 50 μm, and very particularly preferably from 0.3 to 30 μm. The separations of the individual particles on the self-cleaning surfaces are from 0 to 10 particle diameters, in particular from 2 to 3 particle diameters.

The particles present may also be in the form of aggregates or agglomerates, where according to DIN 53 206 aggregates have primary particles in edge- or surface-contact, while agglomerates have primary particles in point-contact. The particles used may also be those composed of primary particles forming agglomerates or aggregates with a size of from 0.2 to 100 μm.

It can be advantageous for the particles used to have a structured surface. The particles used preferably have an irregular fine structure in the nanometer range on the surface. The very fine structure of the particles is preferably a fitted structure with elevations and/or depressions in the nanometer range. The average height of the elevations is preferably from 20 to 500 nm, particularly preferably from 50 to 200 nm. The separation of the elevations and, respectively, depressions on the particles is preferably less than 500 nm, very particularly preferably less than 200 nm.

The particles used, in particular the particles which have an irregular fine structure in the nanometer range on the surface, are preferably ones which comprise at least one compound selected from fumed silica, aluminum oxide, silicon oxide, fumed silicates, and pulverulent polymers. It can be advantageous for the particles used to have hydrophobic properties. Particles which are very particularly suitable, inter alia, are hydro-phobicized fumed silicas, known as Aerosils.

The hydrophobic properties of the particles may be inherently present by virtue of the material used for the particles. However, it is also possible to use hydrophobicized particles which have hydrophobic properties by virtue of, for example, treatment with at least one compound selected from the group consisting of the alkylsilanes, perfluoroalkyl-silanes, paraffins, waxes, fatty esters, functionalized long-chain alkane derivatives, and alkyldisilazanes.

For the process of the present invention it is also possible for the particles to be given hydrophobic properties after securing to the carrier. In this case, too, the particles are preferably given hydrophobic properties by virtue of treatment with at least one compound selected from the group consisting of the alkylsilanes, perfluoroalkylsilanes, paraffins, waxes, fatty esters, functionalized long-chain alkane derivatives, and alkyldisilazanes.

The solvent which contains the particles preferably contains them in suspended form. The solvents used may be any of the solvents which are capable of solvating the appropriate polymer present in the polymer surface. Suitable solvents for these applications are in principle any of the solvents for the polymers concerned. An example of a finite, but not comprehensive, list is in Polymer Handbook, Second Edition; J. Bandrup, E. H. Immergut; in Chapter IV, Solvents and Non-Solvents for Polymers, for example. This list includes other polymers not listed below and their solvents, which are likewise intended by inclusion within the invention.

The solvent used is preferably at least one compound suitable as a solvent for the appropriate polymer and selected from the group consisting of alcohols, glycols, ethers, glycol ethers, ketones, esters, amides, aliphatic hydrocarbons, aromatic hydrocarbons, nitro compounds, and/or halogenated hydrocarbons, or a mixture of two or more of these compounds. The solvent used is very particularly preferably at least one compound suitable as a solvent for the appropriate polymer and selected from methanol, ethanol, propanol, butanol, octanol, cyclohexanol, phenol, cresol, ethylene glycol, diethylene glycol, diethyl ether, dibutyl ether, anisole, dioxane, dioxolane, tetrahydrofuran, monoethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol esters, dimethyl-formamide, pyridine, N-methylpyrrol-idone, N-methyl-caprolactone, acetonitrile, carbon disulfide, dimethyl sulfoxide, sulfolane, nitrobenzene, dichloromethane, chloroform, tetrachloromethane, tri-chloroethene, tetrachloroethene, 1,2-dichloro-ethane, chlorophenol, chlorofluorohydrocarbons, petroleum spirits, petroleum ethers, cyclohexane, methyl-cyclohexane, decalin, tetralin, terpenes, benzene, toluene, and/or xylene, or a mixture made from two or more of these compounds suitable as solvents.

Use of the various solvents permits the use of almost any polymer as polymer surface. The decisive factor in selecting the solvent is that the particulate system is not attacked by the solvent whereas the polymer system is solvated.

A very wide variety of common polymers may form the polymer surface. The polymer forming the polymer surface is preferably at least one polymer selected from polycarbonates, polyacrylonitriles, poly(meth)acrylates, polyamides, PVC, polyethylenes, poly-alkylene terephthalates, polypropylenes, polystyrenes, polyesters, and polyether sulfones, and also mixtures and copolymers of these, where the monomers for the copolymers may also come from other classes of monomer.

The solvent which contains the particles may be applied at room temperature to the polymer surface. In one particularly preferred embodiment of the process of the invention, the solvent which comprises the particles is heated, prior to application to the polymer surface, to a temperature of from −30 to 300° C., preferably from 25 to 100° C., preferably to a temperature of from 50 to 85° C.

The application of the solvent comprising the particles to the polymer surface may be by spray-application, doctor-application, drop-application, or by dipping the polymer surface into the solvent comprising the particles, for example.

The number of particles introduced onto the surface can be regulated via the concentration of particles in the solvent and the temperature of the solvent, and also via the immersion time. The rule here is that the longer the contact time and the more suitable the solvent, the greater the number of particles introduced into the polymer. However, the disadvantage of a long contact time is that not only does the uppermost layer of the polymer become solvated but other more deep-lying polymer layers become solvated or swollen. This can lead to undesirable complete destruction of the polymer. Dimensional change in polymeric moldings can also occur. The following parameters have proven particularly suitable. The concentration of the primary particles in the solvent is preferably from 0.1 to 20% by weight, particularly preferably from 1 to 12% by weight, and very particularly preferably from 1 to 7% by weight. The contact times are highly dependent on the solvent and the temperature. The contact time is preferably from 1 sec to 75 min, particularly preferably from 1 sec to 1 min, and very particularly preferably from 1 sec to 10 sec. However, short contact times and, where appropriate, repeated dipping of the specimen has proven successful for avoiding distortion of the external shape of the polymeric molding. An ultrasound bath may be used to deagglomerate the agglomerated particles, and the particles can be kept suspended by continuous stirring.

The process of the invention can produce a self-cleaning polymer surface which has an artificial, at least partially hydrophobic, surface structure made from elevations and depressions, where the elevations and depressions are formed by particles secured to the polymer surface.

The self-cleaning polymer surfaces of the invention have particles of a material selected from silicates, doped silicates, minerals, metal oxides, silicas, fumed silicas, precipitated silicas, metal powders, and polymers. The polymer surfaces also comprise at least one polymer selected from polycarbonates, poly(meth)acrylates, polyamides, PVC, polyethylenes, polypropylenes, polystyrenes, polyesters, and polyether sulfones, and their mixtures and copolymers. The particles secured to the polymer surface preferably have an average particle diameter of from 0.02 to 100 μm, preferably from 0.2 to 50 μm, and particularly preferably from 0.1 to 30 μm. The particles may also be present in the form of aggregates or agglomerates, where in accordance with DIN 53 206 aggregates have primary particles in edge- or surface-contact, while agglomerates have primary particles in point-contact.

In one very particularly preferred embodiment, the self-cleaning polymer surface of the invention comprises particles which have an irregular fine structure in the nanometer range on the surface. The presence of a fine structure in the nanometer range on the surface of the particles achieves particularly effective self-cleaning action, since the separation of the elevations and depressions is not purely a function of the separation of the particles, and therefore of the particle size, but is also a function of the separation between the elevations and depressions on the particles.

The particles on the polymer surface of the invention preferably have hydrophobic properties. The hydrophobic properties of the polymer surface and, respectively, of the particles achieves a surface structure which is at least partially hydrophobic and by way of which the self-cleaning action of the surfaces can be increased as desired, since contamination on the surface can be removed by using small amounts of water, or automatically by rain (self-cleaning effect).

The process of the invention can produce objects with a self-cleaning surface. These objects are obtainable by coating the object with at least one polymer in order to obtain a polymer surface, and then securing particles to this polymer surface by means of the above-described process.

Having generally described this invention, a further understanding can be obtained by reference to certain specific examples which are provided herein for purposes of illustration only and are not intended to be limiting unless otherwise specified.

### EXAMPLES

### Example 1

### Self-Cleaning Surface Based on a Polypropylene Surface

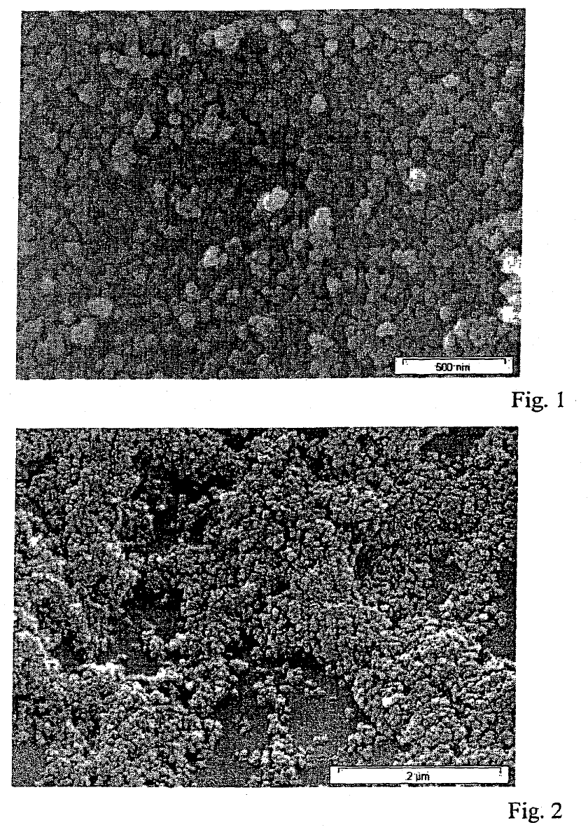

Decalin is heated to a temperature of 80° C. The decalin comprises 3% by weight of fumed silica (Aerosil R 8200, Degussa AG). Aerosil R 8200 is a hydrophobic Aerosil with a primary particle size distribution of from about 5 to 50 μm. An ultrasound bath is used to deagglomerate agglomerated particles. The solution is kept continuously stirred. A polypropylene sheet of dimensions 5×5 cm is dipped in the suspension for about 3 sec. Once the solvent has been dried off, the sheet is dipped for a second time in the suspension for 3 sec. FIG. 1 shows an SEM of the resultant self-cleaning lotus surface. The SEM clearly shows that the particles have been bonded into the polymer matrix. The resultant surface has the same chemical stability as the polypropylene and exhibits a very good lotus effect. Water droplets roll off at an angle of as little as 4°, and if the surface is soiled using carbon black, even very small amounts of water are sufficient to render the surface again completely free from carbon black.

### Example 2

### Self-Cleaning Surface Based on a Polyester Surface

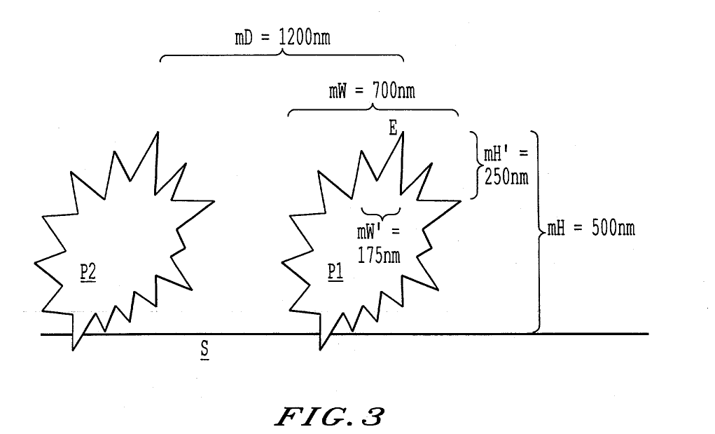

3% by weight of fumed silica (Aerosil R 8200, Degussa AG) are suspended in hot dimethyl sulfoxide (DMSO). A commercially available polyester sheet of dimensions 5×5 cm is dipped in this solution for 5 sec. FIG. 2 shows an SEM of the primary particles bonded into the polyester. Here again, a very good self-cleaning effect (lotus effect) is observed. Water droplets roll off spontaneously at an angle as small as 14° and if the surface is soiled with carbon black even very small amounts of water are sufficient to render the surface again completely free from carbon black.

The disclosure of German priority patent application 10118349.6, filed Apr. 12, 2001, is hereby incorporated by reference.

1. A process for producing self-cleaning surfaces, in which an at least partially hydrophobic, surface structure is formed by securing particles on a polymer surface, which comprises applying, to the polymer surface, at least one solvent which comprises the particles and which solvates the polymer surface, and securing at least part of the particles to the polymer surface by removing the solvent.

2. The process as claimed in claim 1, wherein the particles are made of a material comprising at least one material selected from silicates, doped silicates, minerals, metal oxides, silicas, and polymers.

3. The process as claimed in claim 1, wherein the particles are suspended in the solvent.

4. The process as claimed in claim 1, wherein the polymers forming the polymer surface comprise at least one polymer or copolymer selected from the group consisting of polycarbonates, polyacrylonitriles, poly(meth)acrylates, polyamides, PVC, polyalkylene terephthalates, polyethylenes, polypropylenes, polystyrenes, polyesters, and polyether sulfones.

5. The process as claimed in claim 1, wherein the solvent comprises at least one solvent selected from the group consisting of alcohols, glycols, ethers, glycol ethers, ketones, esters, amides, organic nitrogen compounds, organic sulfur compounds, nitro compounds, halogenated hydrocarbons, and hydrocarbons.

6. The process as claimed in claim 5, wherein the solvent comprises at least one solvent selected from the group consisting of methanol, ethanol, propanol, butanol, octanol, cyclohexanol, phenol, cresol, ethylene glycol, diethylene glycol, diethyl ether, dibutyl ether, anisole, dioxane, dioxolane, tetrahydrofuran, mono-ethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol esters, dimethylformamide, pyridine, N-methyl-pyrrolidone, N-methylcaprolactone, acetonitrile, carbon disulfide, dimethyl sulfoxide, sulfolane, nitrobenzene, dichloromethane, chloroform, tetra-chloromethane, trichloroethene, tetrachloro-ethene, 1,2-dichloroethane, chlorophenol, chloro-fluorohydro-carbons, petroleum spirits, petroleum ethers, cyclohexane, methylcyclo-hexane, decalin, tetralin, terpenes, benzene, toluene, and xylene.

7. The process as claimed in claim 1, wherein the solvent comprising the particles is heated, prior to applying to the polymer surface, to a temperature of from −30 to 300° C.

8. The process as claimed in claim 7, wherein the temperature is from 25 to 100° C.

9. The process as claimed in claim 8, wherein the temperature is from 50 to 85° C.

10. The process as claimed in claim 2, wherein the particles have an average particle diameter of from 0.02 to 100 μm.

11. The process as claimed in claim 10, wherein the particles have an average particle diameter of from 0.3 to 30 μm.

12. The process as claimed in claim 1, wherein the particles have an irregular fine structure in the nanometer range on the surface.

13. The process as claimed in claim 1, wherein the particles are made of a material comprising at least one compound selected from the group consisting of fumed silica, aluminum oxide, silicon oxide, fumed silicates and pulverulent polymers.

14. The process as claimed in claim 1, wherein the particles have hydrophobic properties.

15. The process as claimed in claim 14, wherein the hydrophobic properties have been obtained by treatment of the particles with at least one compound selected from the group consisting of alkylsilanes, perfluoroalkyl-silanes, paraffins, waxes, fatty esters, functionalized long-chain alkane derivatives and alkyldisilazanes.

16. The process as claimed in claim 1, wherein hydrophobic properties are imparted to the particles after securing the particles to the polymer surface.

17. The process as claimed in claim 16, wherein the hydrophobic properties are imparted to the particles by treatment with at least one compound selected from the group consisting of the alkylsilanes, perfluoroalkylsilanes, paraffins, waxes, fatty esters, functionalized long-chain alkane derivatives, and alkyldisilazanes.

18. A self-cleaning polymer surface produced by a process as claimed in claim 1, and having an artificial, at least partially hydrophobic, surface structure made from elevations and depressions, wherein the elevations and depressions are formed by said particles secured to the polymer surface.

19. The self-cleaning polymer surface as claimed in claim 18, wherein the particles are made of a material comprising at least one material selected from silicates, doped silicates, minerals, metal oxides, silicas, and polymers.

20. The self-cleaning polymer surface as claimed in claim 18, wherein the polymers forming the polymer surface comprise at least one polymer or copolymer selected from the group consisting of polycarbonates, polyacrylonitriles, poly(meth)acrylates, polyamides, PVC, polyalkylene terephthalates, polyethylenes, polypropylenes, polystyrenes, polyesters, and polyether sulfones.

21. The self-cleaning polymer surface as claimed in claim 18, wherein the particles have an average particle diameter of from 0.02 to 100 μm.

22. The self-cleaning polymer surface as claimed in claim 21, wherein the particles have an average particle diameter of from 0.1 to 30 μm.

23. The self-cleaning polymer surface as claimed in claim 18, wherein the particles have an irregular fine structure in the nanometer range on the surface.

24. The self-cleaning polymer surface as claimed in claim 18, wherein the particles have hydrophobic properties.

25. The self-cleaning polymer surface as claimed in claim 18, wherein individual particles are separated from each other on the surface by from 0 to 10 particle diameters.

26. The self-cleaning polymer surface as claimed in claim 25, wherein individual particles are separated from each other on the surface by from 2 to 3 particle diameters.

27. An object with a self-cleaning surface, obtainable by coating the object with at least one polymer to form a polymer surface, and then securing particles to this polymer surface by a process as claimed in claim 1.
